(19) United States
(12) Patent Application Publication
(10) Pub. No.: US 2025/0086850 A1
(43) Pub. Date: Mar. 13, 2025

(54) GENERATING TRAINING IMAGES

(71) Applicant: HyperCinema Ltd, Auckland (NZ)

(72) Inventors: Gareth HORDYK, Auckland (NZ); Tarver James GRAHAM, Auckland (NZ); Miles Richard James LATTIMER-GREGORY, Auckland (NZ); Charles Eric DRUMMOND, Auckland (NZ)

(21) Appl. No.: 18/827,252

(22) Filed: Sep. 6, 2024

(30) Foreign Application Priority Data
Sep. 8, 2023 (NZ) 803525

(51) Int. Cl. G06T 11/00; G06V 10/26; G06V 10/774; G06V 40/16

(52) U.S. Cl. CPC G06T 11/00; G06V 10/26; G06V 10/774; G06V 40/168; G06T 2210/16

(57) ABSTRACT

A computer implemented method of generating at least one likeness of a specific human subject for use in the generation of a media product comprises receiving subject capture data from a capture session in respect of the specific human subject, wherein the subject capture data is captured using at least one capture device, processing the subject capture data to generate a training data set from the subject capture that enables separation of facial features of the specific human subject from other features, and using an AI algorithm with the training data set to at least one of generate at least one likeness of the specific human subject, and train an AI model to generate likenesses of the specific human subject.

### CROSS REFERENCE TO RELATED APPLICATIONS

This patent application claims the benefit and priority of New Zealand Patent Application No. 803525, filed with the New Zealand Intellectual Property Office on Sep. 8, 2023, the disclosure of which is incorporated by reference herein in its entirety as part of the present application.

### FIELD

Embodiments of the invention provide a computer implemented method of generating images for training an AI model, and a computer implemented method of generating a media product using the trained AI model.

### BACKGROUND

Traditional media experiences, such as cinema and entertainment experiences, have remained largely unchanged, offering standardized content to mass audiences. There is a need for alternative methods of generating media products that can be used, for example, to provide alternative entertainment or advertising experiences.

### BRIEF SUMMARY

According to an aspect of the technology there is provided a computer implemented method of generating at least one likeness of a specific human subject for use in the generation of a media product, the method comprising:
receiving subject capture data from a capture session in respect of the specific human subject, wherein the subject capture data is captured using at least one capture device;
processing the subject capture data to generate a training data set from the subject capture that enables separation of facial features of the specific human subject from other features; and
using an AI algorithm with the training data set to at least one of:
   generate at least one likeness of the specific human subject; and
   train an AI model to generate likenesses of the specific human subject.

In an embodiment, the AI algorithm trains an AI model pre-trained to generate likenesses of human subjects, with the training data set to thereby generate an instance of the AI model trained to generate likenesses of the specific human subject.

In an embodiment, the method further comprises conducting the capture session using the at least one capture device.

In an embodiment, the method further comprises conducting the capture session in a capture booth comprising at least one capture device.

In an embodiment, the method further comprises conducting the capture session at a kiosk comprising at least one capture device.

In an embodiment, the capture data comprises at least one of a plurality of images captured in the capture session and video from which a plurality of images can be extracted.

In an embodiment, the method further comprises processing the plurality of images to generate a larger set of images, and outputting the larger set of images as the training data set.

In an embodiment, processing the plurality of images to generate a larger set of images comprises one or more of:
generating at least one image having a different viewpoint;
generating at least one image having a modified background;
generating at least one image in which the subject's clothing is modified; and
generating different crop levels for at least one image.

In another aspect of the technology, there is provided a computer implemented method of generating a media product comprising generating likenesses of a specific human subject using at least one of the algorithm and model trained to generate likenesses of the specific human subject as described above.

In an embodiment, generating the media product comprises generating the media product based on at least one prompt comprising a predefined prompt which has been combined with data received from the specific human subject.

In an embodiment, n generating the media product comprises generating the media product based on at least one prompt combined through the AI algorithm with images captured of the specific human subject.

In another embodiment, the method comprises generating a working likeness of the specific human subject by using a pretrained model and a prompt derived from a computer generated analysis of the appearance of the specific human subject and the AI algorithm generates the at least one likeness from the training data set and the working likeness.

Further aspects of the technology, which should be considered in all its novel aspects, will become apparent to those skilled in the art upon reading of the following description which provides at least one example of a practical application of the technology.

### BRIEF DESCRIPTION OF THE DRAWINGS

One or more embodiments of the technology will be described below by way of example only, and without intending to be limiting, with reference to the following drawings, in which:

FIG. 1 is a functional block diagram of the components of the system.

FIG. 2A is a schematic side view of an image capture booth.

FIG. 2B is a schematic plan view of an image capture booth.

FIG. 3 shows a set of fifteen defined poses.

FIG. 4 illustrates an image cropping process.

FIG. 5 illustrates applying defined scenarios to cropped images.

FIG. 6 is a flow chart of an example process for generating images of a training set.

FIG. 7A is a diagram showing a side on view of the kiosk implementation of image capture apparatus 702 using displayed guides and a reference mark which is placed relative to the orientation of the head of the human subject 700.

FIG. 7B is a diagram showing a front view of a kiosk image capture apparatus 702 showing the screen 702 with displayed guides 704 and a reference mark 703 which is placed relative to the orientation of the head of the human subject based upon analysis of input from the at least one capture device 701.

### DETAILED DESCRIPTION

Examples of the technology employ Artificial Intelligence (AI) imaging systems (also known as AI models) as part of a process for generating media products personalised for an individual (or “subject”). Examples of the technology relate to a computer implemented method of training an Artificial Intelligence (AI) model to produce likenesses of a subject, and media products produced with likenesses of the subject generated by the trained AI model. Examples of the technology generate likenesses of the subject for personalised media products, such as personalised movies, comic strips (digital or printed), media exhibitions, an electronic game, personalised advertisements, or story books (digital or printed).

In order to train an AI model, generally the dataset must be curated to provide a representative sample of the pattern to be recognised without unintentional biases. The training process for generative AI models, in effect, associates similarities in the dataset with a symbol or token by which that pattern can later be invoked—e.g. the word “elephant” invokes a picture of an elephant. In general, a first class of AI models are trained with a large variety of patterns. For example, if an AI model is intended to output likenesses of human subjects, it may be trained with a large number of images of different human subjects so that it can learn the pattern of a human subject. Other algorithms are trained specifically on a likeness from images of a subject's face, and use that likeness to generate new images from that likeness and a pre-existing or generated target image.

The first class of model can then be finetuned via further training to be able to output a likeness of a specific subject. Conventional approaches involve gathering a set of training images that consists of a number of photos of the subject that span a period of time (months to years) and in a variety of situations (day, night, indoors, outdoors), with differing facial expressions, at different angles to the camera, and with the subject wearing different clothing. Curating a data set in this manner allows the AI model to extract the pattern of the individual subject. However, providing such a training data set provides a high barrier to entry when attempting to train a model at the time of use as there is no access to the necessary variety of images.

Data sets consisting of images that are captured over a short period of time at the point of need are unlikely to be effective for training an AI model because there will be many other similarities between recorded images—such as clothing, background scenery etc. Such similar details become a confounding issue for a fine-tuning training process in that in many cases, after an AI model has been trained with such images, invoking the likeness of the subject will also invoke aspects of those other details, limiting the flexibility of the model.

Examples of the technology employ a process referred to as segmentation in order to enable an AI model to separate the likeness of the subject from other details which are not intended to be part of the training set, and thus enable fine tuning training of an AI model to be effective.

Various techniques can be used to capture a subject and apply segmentation to the captured data to generate a training data set. One example of the technology employs a capture process that involves taking images of a subject captured in a photography session in a controlled environment in a relatively short time period (e.g. 1 to 2 minutes) and processing the captured images to create a training image set suitable for training an AI model. In some examples, the technology is capable of generating a number of artificially varied images, with the appearance of having been collected in a variety of situations, that can then be used to generate a strong and flexible AI model. These images are generated by augmenting the images captured during the photography session.

Once trained, the AI model is used with other software modules or AI algorithms to generate a personalised media product.

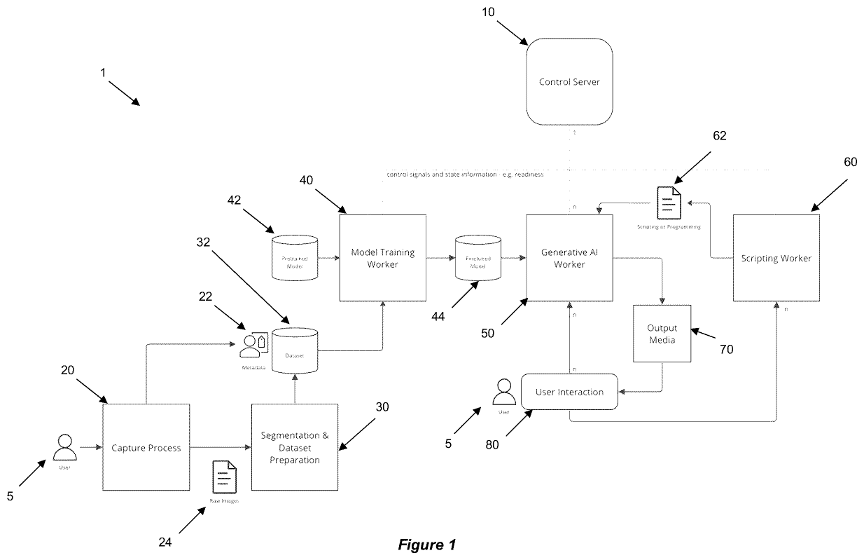

FIG. 1 is a functional block diagram of the components of an example system 1 for generating media products. For example, for an exhibition or gallery experience. The system 1 is exemplified in respect of a single user (or subject), however, in some examples, a media product may be generated for multiple users whose likenesses are captured at the same or different locations, and may be displayed at the same or different locations.

FIG. 1 shows that a user 5 engaging with the system 1 via a capture process module 20 and a user interaction module 80. In this example, the user interaction module's 80 main outputs are used as inputs to the scripting worker 60 and generative AI worker 50. However, in an example the user interaction module 80 is also used for tasks such as enrolling the user in system 1 in order that user metadata 22 can be associated with the user's dataset 32. In other examples, enrolment data may be gathered separately as part of the capture process 20.

Capture process module 20 incorporates one or more capture devices. In example implementations, the capture device may be one or more still cameras used to capture images of the user or one or more video cameras used to capture a video recording of the user. In some examples, still images may be extracted from a video recording. In some implementations, other capture devices may be employed, such as capture devices that enable the capture of a three-dimensional model of the user—for example a point cloud model of a user may be generated using a laser scanning device or varied monocular and binocular computer vision techniques. As exemplified by the image capture booth 500 described below, the capture module 20 may incorporate other components to facilitate the capture process.

In this example, the output of the capture process module 20 is fed to the segmentation and data preparation module 30. As indicated above, one example of the output may be raw images 24 of the subject captured using a still camera or extracted from a video. In some examples, segmentation is achieved by segmentation and data preparation module 30 processing the raw images to create a larger set of images of the subject in which facial characteristics of the subject are retained but other features of the image are changed in order to enable the AI model to separate the likeness of the subject from other details which are not intended to be part of the training set. The larger set of images is combined with metadata 22 to form a user dataset 32.

In some examples, the capture process module 20 may facilitate self-capture by the user, either through extraction of frames of a video or the capture of a series of photographs. In such an example, segmentation and data preparation module 30 may generate additional angles or modified viewpoints through the use of computer vision techniques—e.g from angles not directly observed by the camera, perform segmentation of the face (to be preserved) and make the background and clothing distinctive (e.g. modifying the background through the use of generative AI). These images may then used to form a training dataset for more general recreation of the likeness of the individual.

In an embodiment of the system 1 a control server 10 implements logic to control the training process and the subsequent process of generating a media product. Each time a user dataset 32 is ready, control server 10 controls model training worker 40 to conduct fine tuning training of a pre-trained AI model 42 based on the user dataset 32, in order to output a fine tuned AI model 44 specific to the user. Accordingly, system 1 maintains a fine tuned AI model 44 for each active user.

In order to assist in personalising the media product, user interaction module 80 may present questions to the user and capture the user's answers, e.g. via a webpage server to a user's electronic device. The questions may capture information about the user ranging from basic information to an indication as to how the user may respond in a particular situation. The answers to the questions may also inform a type of media product produced or a theme of the media product. In an example, the answers to the questions are provided to a scripting worker 60. Scripting worker 60 combines the answers with predefined scripting data to generate a script 62 or programming for generative AI worker 80. In an example, the script is a series of prompts for the generative AI worker 80 to generate and assemble different portions of the media product. For example, a predefined prompt may have a defined region into which an answer is inserted to create a prompt that is a mixture of Generative AI worker 80 may employ a plurality of different processes to generate and output the media product 70. For example, in addition to using the finetuned AI model to generate likenesses of the subject, a separate language model AI (e.g. ChatGPT) may be used to create pieces of content about the user, or the original image dataset may be used as a reference for other generative algorithms to improve the likeness of generated images to the original subject. Some of these may be displayed as text, others may be spoken, others used as information to create a story about the user, etc. Generative AI worker 80 may incorporate some functions that don't use AI generation to perform specific tasks in the creation of the end media product. For example, where the media product is a comic strip, there may be a function to insert generated images and text into a comic strip format. Other functions implemented by generative AI worker 80 may include, voice generation based on text input, aligning speech with video (e.g. lip synching), the generation of reference poses using standard 3D animation techniques, other graphical or video editing techniques etc.

As shown in FIG. 1, in some examples, the media product 70 may be output to the user interaction module to enable user interaction, for example, where the media product is a game. Such interaction may be fed back directly into the generative AI worker (e.g. as a prompt) or to the scripting worker which may inject the feedback into a modified script 62. In embodiments where multiple users interact with the system (e.g. in the same way as a multiplayer online game), the system may create media and scripting according to the actions of multiple users. In this respect, central coordination may allow the generation of a coherent narrative from multiple interactions, and the delivery of content to multiple users synchronously.

In some examples, there may be additional AI models and scripts not related to users—e.g. to generate world elements or characters in a game.

It will be appreciated that the embodiments differ from a video game or cinematic work in that the content is not produced by means of simulation or reproduction, but rather by means of generation.

In some example embodiments, the system may enable the user to interact with the generative AI worker to generate alternative products, such as merchandise (e.g. t-shirts, coffee mugs or the like) with likenesses created using the fine tuned model 44.

In some examples, the output media may be an exhibition displayed in an exhibition space and the user may be provided with an RFID tag or similar for activating portions of the exhibition as they move around the exhibition, each portion being personalised to the user.

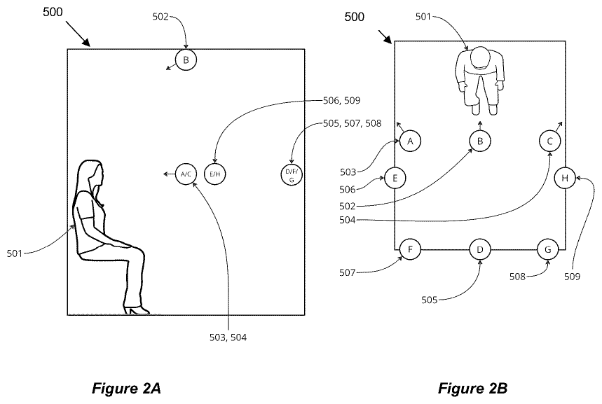

As indicated above, in one embodiment, the capture process may involve capturing images of the subject in a controlled environment. An example image capture booth 500 is shown in FIGS. 2A and 2B. In an example, the image capture booth 500 is a confined space such as a cubic chamber. Each wall is perpendicular to its adjacent walls and parallel to its opposing wall, creating a consistent cubic environment around the subject.

In order to capture images of the subject, the subject 501 is positioned within the image capture booth 500. The subject sits on a seat (not shown), the height of the seat is adjusted to bring the subject's head to the same level as a camera 505. In other examples, subject may stand during the image capture process, for example, on a platform that can be raised up and down. Lights 502, 503, 504 are positioned within the image capture booth 500 to illuminate the subject. In an example, light from lights 502, 503, 504 remains of uniform brightness throughout the image capture process. Moving the subject to the height of the camera also ensures consistent lighting of the subject.

It is advantageous for consistent output quality that the subject 501 to have their images captured in precise poses. Doing so enables a balanced variety of training images to be generated for the AI model. Poses may be communicated to the subject in a number of ways. In some examples, an operator may communicate the poses and may operate the camera. In other examples, the poses may be communicated by the control server 10 or alternatively by a local control device (not shown) using pre-recorded commands and a speaker (not shown). In some examples, control server 10 may automatically operate the camera to capture the images—e.g. after outputting a countdown message via speaker. In some examples, the poses may be displayed on one or more electronic display screens(not shown). In some examples, images of the subject may be displayed on the electronic display screen(s) along with one or more guide boxes to provide visual feedback to the subject. In some examples, the control server may automatically capture the images when it is detected that the subject satisfies alignment criteria.

In an example, the orientation of the subject's body and the head are set separately for each pose. In an example, five reference points are provided within image capture booth 500. In an example, four of the reference points are signs with numbers 506-509 positioned on the walls of image capture booth and the final reference point is provided by camera 505. From the subject's right to left, the reference points are first reference point “1” 506, second reference point “2” 507, the camera 505 (effectively number “3” or the third reference point), fourth reference point “4” 508, and fifth reference point “5” 509. In an example, numbers “1” 506 and “5” 509 are positioned so that the subject's head is turned as far to the side as possible, but with both eyes clearly visible; number “2” 507 is equidistant between number “1” 506 and the camera 505; and number “4” is equidistant between number “5” 509 and the camera 505.

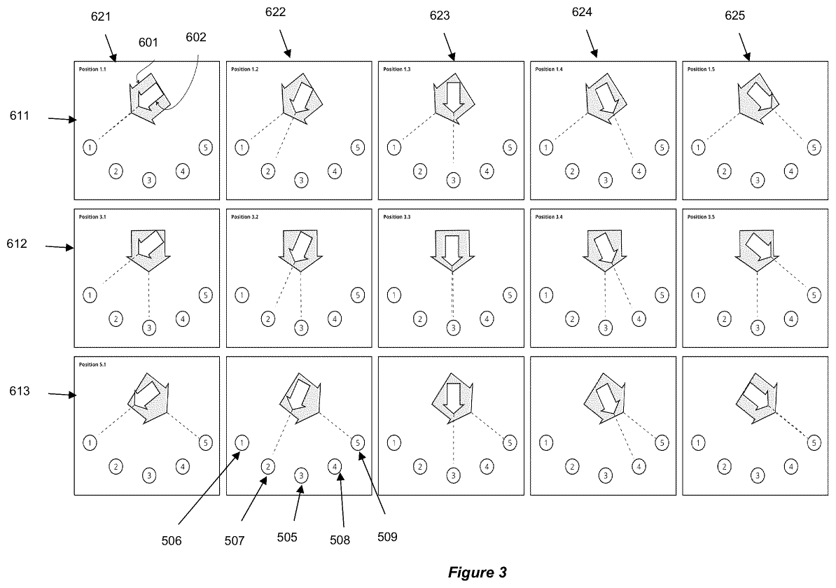

In an example, fifteen images are taken in total. In FIG. 3, a set of fifteen defined poses are set out in three rows 611-613 and five columns 621-625. In each pose, orientations are defined relative to the five reference points 505-509. In each pose, large arrow 601 defines the desired orientation of the subject's body position relative to a reference point and small arrow 602 defines the desired orientation of the subject's body position relative to a reference point. For example, the pose in the middle/third column 623 and the top row 611 defines that the subject should orient their body towards reference point “1” and their head towards reference point 3 (i.e. camera 505). It will be appreciated that in this example, there are three different body positions (represented by each row 611-613) and five head positions (represented by each column 621-625). Capturing fifteen images has been found to enable AI model to be trained effectively with a reasonable amount of capture time. However, other numbers of images may be captured. For example, the reference points 505-509 of example image capture booth could be used to define twenty-five different poses by using each reference point to define a body position of a pose. In other examples, not all reference positions are used for a head position in combination with a body position. For example, combinations of body positions and head position that require a large head movement may be excluded—e.g. the pose in the top row 611 and fifth column 625. Other examples, may employ different number of reference points and may employ reference points at different elevations—e.g. reference points above and below camera 505. In other examples, multiple cameras may be used to remove or reduce the need for repositioning the subject.

In an example, the subject is instructed to retain a neutral expression throughout the image capture process.

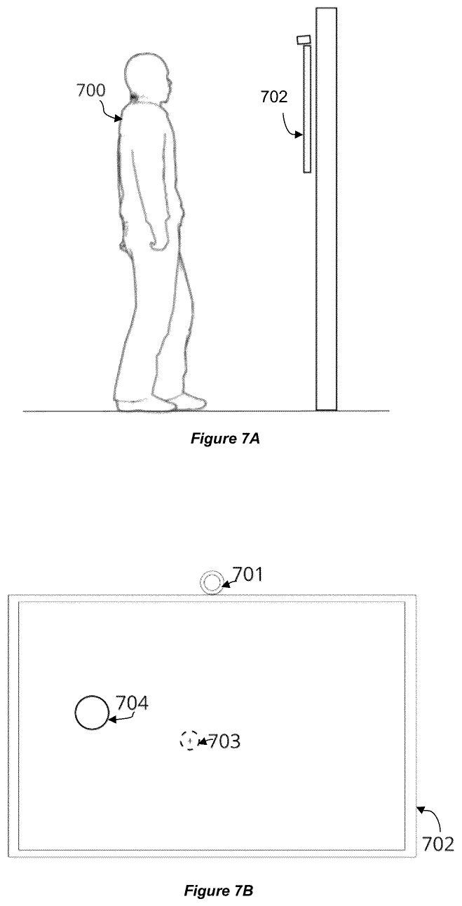

In another example illustrated in FIG. 7, a capture kiosk is provided comprising at least one image capture device 701, and a computer or tv screen 702. In this example, the subject is instructed to perform a variety of expressions, or recorded while responding to images or video on screen. In an example, reference marks or guides are shown on a computer or tv screen 702 in front of a standing or seated human subject. The at least one capture device 701 is positioned on or near the periphery of the screen 702 and pointed at the subject. The orientation of the human subject's face is detected through computer analysis of information from the capture device 701. The information from this process is used to calculate the position of a reference mark 703 that moves as the human subject changes the orientation of their head. Guides 704 which define a desired orientation are displayed on screen, and the human subject is given instructions through text on screen or by audio message through a speaker (not pictured) instructing them to move the mark 703 into the area defined by the guides by adjusting the orientation of their head. Once the mark is in that location a short delay optionally accompanied with a visual display is initiated to ensure that the subject remains still in the correct orientation, after which an image is captured through the capture device 701. In some examples, instructions may also be given to change facial expressions at the orientations, after which another image is captured. The process is then repeated in order to capture images at a range or orientations by moving the guide to a range of positions. The images so captured are then processed as described below.

The captured images are stored as a user data set 32 in a user database in a record for the user that is set-up for the subject during an enrolment process.

In an example, the segmentation and dataset preparation module 30 includes an automatic image cropper. In some examples, the images may be pre-processed to exclude images with undesirable characteristics such as images in which the subject's eyes are shut or in which the subject has failed to retain a neutral expression. In some examples, this may involve presenting the images to an operator for review. In other examples, a trained neural network may be used to exclude images with undesirable characteristics.

In the example, all images are cropped three times to provide a greater variety of imagery to the AI model. In an example, the original image is never used in training, only images derived from the cropped images. In an example, the cropped images have a 1:1 aspect ratio. Three crop levels are taken, close-up, medium close-up and mid. In an example, the positions and sizes of these crops are determined by the size of the head of the subject.

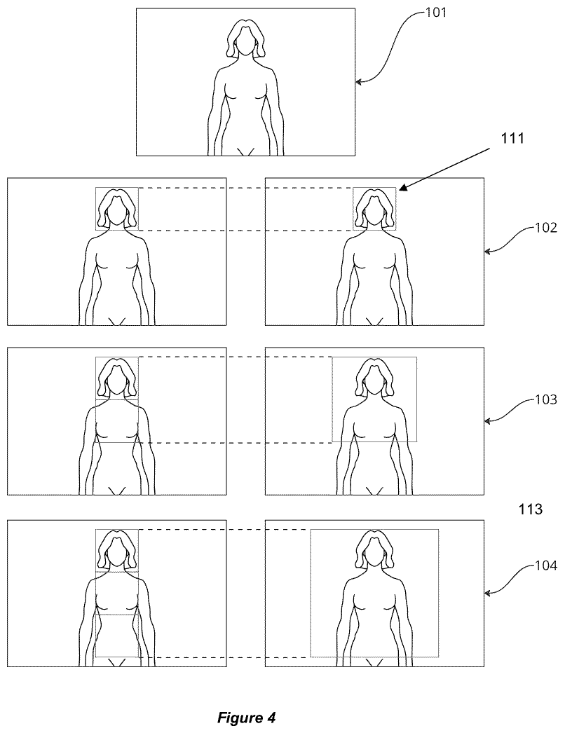

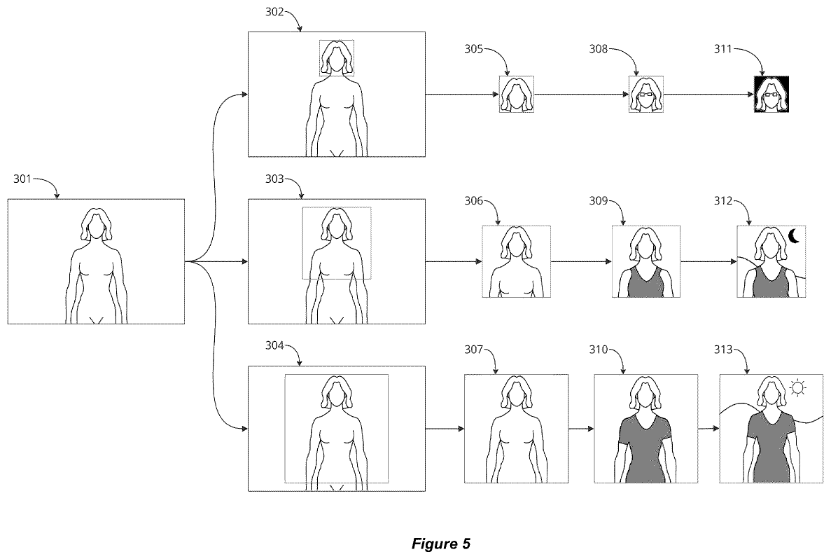

This process is illustrated with respect to an example input image 101 in FIG. 4. In an example, image cropper finds the head 111 of the subject in image 101 and determines the size of the head. In the example, the size of the head is then used to determine the dimensions of the subsequent crops. In this example, close-up crop 102 is a single head height. Medium close-up crop 103 is two head heights and a mid-crop 104 is three head heights. In an example, before the crop is taken a random zoom level, vertical position and horizontal position adjustments is applied, to give extra variety to the output imagery. While the example of FIG. 5 shows each crop touching the top of the subject's head, a border region can be applied—e.g. a defined number of pixels from what has been determined to be the top of the subject's head or based on a defined percentage of the subject's head.

If the position of the subject in the original image prevents a crop type from being taken then that specific crop is ignored by image cropper. Accordingly, in a case where all images are fed to the image cropper and all crops are applied forty-five images are generated but in some cases there may be more or fewer images.

While it has been found that three crops of each image are effective in training the AI model, it will be appreciated that different numbers of crops can be employed. For example, four crops. The number or size of crops can be related to the position in which the subject's images are captured. For example, if images are captured with a standing subject, more crops may be employed or at least one of the crops may capture a larger portion (or all of) the subject's body.

The cropped images are then processed to generate varied images of the subject that can be used as an input to the AI model. That is, to generate a plurality of different images of the subject in which the subject and the subject's background look different in order to provide variety in the training set of images used as the input to the AI model.

In order to generate the varied images, scenarios are defined in a database. Each scenario defines visual characteristics of the relevant image—that is, the appearance of the image to be generated. In some examples, the scenarios that are applied may depend on information captured during the enrolment process, such as gender. That is, different scenario sets may be used for male and female subjects. In other examples, the scenarios may depend on characteristics of a selected media product. Scenarios may be specific to a crop size, for example, there may be a more limited range of scenarios for close-ups as there will typically be fewer image elements to be manipulated within a close-up.

In an example, each scenario defines (a) an outfit (the clothing to be worn by the subject) (b) a scene in (the environment the subject is in); and image variables (e.g. contrast, lightness, brightness, and saturation) to allow the image to be manipulated to imitate different lighting levels, camera types and/or image ages. For example, an example scenario may be:
outfit—a black cocktail dress with sparkling jewellery;
scene—an elegant rooftop party with city lights twinkling in the distance;
contrast—1.2;
lightness—0.9;
brightness—1.0; and
saturation—1.2.

In an example, image assets may be stored as part of the scenario definition in order to enable the image manipulation. Scenarios can define other image manipulations, e.g. to hairstyle, skin tone, etc.

In an example, segmentation and dataset preparation module 30 randomly selects a scenario for each of the cropped images. Using a different random scenario for each cropped image, provides a greater variety of outputs from a single source image 301. In another example, only a subset of the cropped images are processed, for example 21 images. Using 21 images enables a similar number of images to be available for a second attempt to train the AI model in the case that a first attempt fails for some reason.

FIG. 5 illustrates an example of cropping, clothing replacement and background replacement. An input image 301 is processed by: applying a close-up crop 302 to produce a first cropped image 305; applying a medium close-up crop 303 to produce a second cropped image 306; and applying a mid crop 303 to produce a third cropped image 306.

In accordance with a first selected scenario, first cropped image 305 is processed to change the subject's outfit, in this case by adding glasses to the subject as shown in first clothing image 308. A dark background is then applied to the first clothing image 308 and image parameters are adjusted to produce the first training image 311.

In accordance with a second selected scenario, second cropped image 306 is processed to change the subject's outfit, in this case by adding a sleeveless top to the subject as shown in second clothing image 309. A night time background is then applied to the second clothing image 309 and image parameters are adjusted to produce the second training image 312.

In accordance with a third selected scenario, third cropped image 307 is processed to change the subject's outfit, in this case by adding a short sleeved dress to the subject as shown in third clothing image 310. A day time background is then applied to the third clothing image 310 and image parameters are adjusted to produce the third training image 313. In this way, using a different random scenario for each cropped image, provides a greater variety of outputs from a single source image 301.

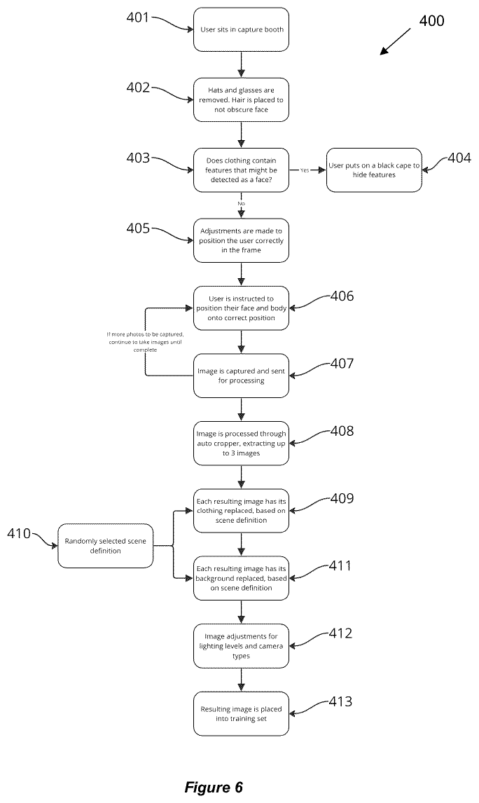

FIG. 6 sets out an example flow chart of a process 400 for training image creation. At step 401, the subject sits in the capture booth. At step 402, the subject is instructed (or in some cases assisted) to remove any hat and/or glasses and adjust their hair so as to not obscure their face.

At step 403, it is determined whether the user's clothing contains features that might be detected as a face, and if it does, the user is instructed to remove the clothing or put on obscuring clothing, such as a black cape at step 404. In current implementations, the decision at step 403 is made by an operator of the capture booth but in other implementations, facial detection software may be employed to process an image of the subject to determine whether more than one face candidate above a defined confidence threshold is located in the image.

At step 405 adjustments (such as the seat height adjustment described above) are made to position the subject in the frame. Then, at step 406 the user is instructed to position their body and face to match the current pose before an image is captured at step 407 and sent for processing. Steps 406 and 407 are repeated for each defined pose (such as the poses described in relation to FIG. 3 above).

At step 408, each captured image is processed through the auto cropper to extract up to three images. At step 410 a scene definition is selected at random. At step 409, the clothing replacement of the scene definition is applied to a current cropped image that is being processed. Each resulting clothing image is then processed at step 411 to replace the background based on the scene definition. Steps 409, 410 and 411 are repeated for each cropped image.

At step 412, image adjustments for lighting levels and camera types are applied before the resulting image is placed in a training set.

Once the training set is complete, it is used as input to an AI algorithm. In an example an AI algorithm can train an AI model which can then be used to generate media outputs. In an example, the AI model is a diffusion model with a variable attention encoder and a neural network tokenisation layer. In an example, the AI model is Stable Diffusion which is provided by Stability AI (www.stability.ai). In an example the AI algorithm uses the training data set to refine the likeness of a working image to generate a likeness of the human subject. In an example the AI algorithm produces a text description of the human subject which is then used with a general-purpose generative AI to produce a working likeness of the human subject. It will be appreciated that aspects of the above process may be adjusted to fit to input requirements of specific AI models or algorithms.

As outlined above, where an AI model is train it can then be called to generate likenesses of the subject during a process for generating a media product for the subject.

As indicated above, various techniques for capture and segmentation are possible including:
1. Isolation and replacement of the background through use of a pre-trained AI model or mathematical techniques such as Otsu thresholding.
2. Superimposition or replacement of clothing using generative AI or an image compositing technique.
3. Isolation and masking of the distinctive likeness of the individual—e.g. through face recognition algorithms and image manipulation.
4. Modelling of the subject using 3D modelling—e.g. through creation of a point cloud via laser scanning or varied monocular and binocular computer vision techniques. Such a model may then be manipulated to render the subject from a variety of angles and isolate facial data.
5. Physical masking and video compositing of the face of the individual—e.g. using a “green screen” or suit to remove unwanted detail.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The technology may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the technology and without diminishing its attendant advantages. It is therefore intended that such changes and modifications be included within the present technology.

1. A computer implemented method of generating at least one likeness of a specific human subject for use in the generation of a media product, the method comprising:
receiving subject capture data from a capture session in respect of the specific human subject, wherein the subject capture data is captured using at least one capture device;
processing the subject capture data to generate a training data set from the subject capture that enables separation of facial features of the specific human subject from other features; and
using an AI algorithm with the training data set to at least one of:
generate at least one likeness of the specific human subject; and
train an AI model to generate likenesses of the specific human subject.

2. The method of claim 1, wherein the AI algorithm trains an AI model pre-trained to generate likenesses of human subjects with the training data set to thereby generate an instance of the AI model trained to generate likenesses of the specific human subject.

3. The method of claim 1, further comprising conducting the capture session using the at least one capture device.

4. The method of claim 1, further comprising conducting the capture session in a capture booth comprising at least one capture device.

5. The method of claim 1, further comprising conducting the capture session at a kiosk comprising at least one capture device.

6. The method of claim 1, wherein the capture data comprises at least one of:
a plurality of images captured in the capture session; and
video from which a plurality of images can be extracted.

7. The method of claim 1, further comprising processing the plurality of images to generate a larger set of images, and outputting the larger set of images as the training data set.

8. The method of claim 7, wherein processing the plurality of images to generate a larger set of images comprises at least one of:
generating at least one image having a different viewpoint;
generating at least one image having a modified background;
generating at least one image in which the subject's clothing is modified; and
generating different crop levels for at least one image.

9. A computer implemented method of generating a media product comprising generating likenesses of a specific human subject using at least one of the algorithm and model trained to generate likenesses of the specific human subject according to the method of claim 1.

10. The method of claim 9, wherein generating the media product comprises generating the media product based on at least one prompt comprising a predefined prompt which has been combined with data received from the specific human subject.

11. The method of claim 9, wherein generating the media product comprises generating the media product based on at least one prompt combined through the AI algorithm with images captured of the specific human subject.

12. A computer implemented method of generating at least one likeness of a specific human subject for use in the generation of a media product:
receiving subject capture data from a capture session in respect of the specific human subject, wherein the subject capture data is captured using at least one capture device;
processing the subject capture data to generate a training data set from the subject capture that enables separation of facial features of the specific human subject from other features; and
generating a working likeness of the specific human subject by using a pretrained model and a prompt derived from a computer generated analysis of the appearance of the specific human subject; and
using an AI algorithm with the training data set to generate at least one likeness of the specific human subject from the training data set and the working likeness.
